(19) United States
(12) Patent Application Publication
(10) Pub. No.: US 2026/0171006 A1
(43) Pub. Date: Jun. 18, 2026

(54) PIXEL CIRCUIT

(71) Applicant: Shanghai AVIC Optoelectronics Co., Ltd., Shanghai (CN)

(72) Inventors: Genshiro KAWACHI, Kawasaki (JP); Jiro YANASE, Kawasaki (JP); Masamichi SHIMODA, Kawasaki (JP)

(73) Assignee: Shanghai AVIC Optoelectronics Co., Ltd., Shanghai (CN)

(21) Appl. No.: 19/407,918

(22) Filed: Dec. 3, 2025

(30) Foreign Application Priority Data
Dec. 17, 2024 (JP) 2024-220722

(51) Int. Cl. G09G 3/32; G09G 3/20

(52) U.S. Cl. CPC G09G 3/32; G09G 3/2007; G09G 2300/0852; G09G 2300/0861; G09G 2310/066; G09G 2310/08; G09G 2330/021

(57) ABSTRACT

A pixel circuit is configured to control light emission of a light-emitting diode. The pixel circuit includes a constant current circuit, a pulse width modulation circuit, a current control switching transistor on a path of lighting current that is supplied from the constant current circuit and flows through the light-emitting diode, and a bypass switching transistor connected to an anode of the light-emitting diode. The bypass switching transistor is configured to be controlled synchronously with the current control switching transistor. The current control switching transistor is turned ON and then turned OFF by a first pulse signal based on a pulse control-signal from the pulse width modulation circuit and the bypass switching transistor is turned OFF and then turned ON by a second pulse signal based on the pulse control-signal from the pulse width modulation circuit to control an emission period of the light-emitting diode.

### CROSS-REFERENCE TO RELATED APPLICATIONS

This non-provisional application claims priority under 35 U.S.C. § 119(a) on Patent Application No. 2024-220722 filed in Japan on Dec. 17, 2024, the entire content of which is hereby incorporated by reference.

### BACKGROUND

This disclosure relates to a pixel circuit.

Display devices utilizing micro-light-emitting diodes (micro-LEDs) employ pulse with modulation (PWM) driving that modulates the emission periods to display halftones. Among a plurality of PMW driving methods, analog PWM driving has been standardized in recent years.

The pixel circuit to be driven by the analog PWM includes a constant current generation (CCG) unit, a PWM unit, and a switch. The CCG unit generates constant current. The PWM unit compares a gray-level data voltage representing gray-level data with a ramp voltage and converts the gray level data voltage to a pulse signal. The switch turns ON/OFF the current generated by the CCG unit in accordance with the pulse signal from the PWM unit.

The analog PWM driving requires rectangular pulses for the ideal driving current; however, the current by the actual circuit does not fall instantly and its finite falling time (transition time) provides a limitation to the low gray-level display range. Reduction of this falling time is a major issue.

### SUMMARY

An aspect of this disclosure is a pixel circuit configured to control light emission of a light-emitting diode. The pixel circuit includes a constant current circuit, a pulse width modulation circuit, a current control switching transistor on a path of lighting current that is supplied from the constant current circuit and flows through the light-emitting diode, and a bypass switching transistor connected to an anode of the light-emitting diode. The bypass switching transistor is configured to be controlled synchronously with the current control switching transistor. The current control switching transistor is turned ON and then turned OFF by a first pulse signal based on a pulse control-signal from the pulse width modulation circuit and the bypass switching transistor is turned OFF and then turned ON by a second pulse signal based on the pulse control-signal from the pulse width modulation circuit to control an emission period of the light-emitting diode.

Another aspect of this disclosure is a display device including a display region including a plurality of light-emitting diodes and a plurality of pixel circuits configured to control light emission of the plurality of light-emitting diodes, and a control circuit disposed outside the display region and configured to control the plurality of pixel circuits. Each of the plurality of pixel circuits includes a constant current circuit, a pulse width modulation circuit, a current control switching transistor on a path of lighting current that is supplied from the constant current circuit and flows through the light-emitting diode, and a bypass switching transistor connected to an anode of the light-emitting diode. The bypass switching transistor is configured to be controlled

synchronously with the current control switching transistor. The current control switching transistor is turned ON and then turned OFF by a first pulse signal based on a pulse control-signal from the pulse width modulation circuit and the bypass switching transistor is turned OFF and then turned ON by a second pulse signal based on the pulse control-signal from the pulse width modulation circuit to control an emission period of the light-emitting diode.

It is to be understood that both the foregoing general description and the following detailed description are exemplary and explanatory and are not restrictive of this disclosure.

### BRIEF DESCRIPTION OF THE DRAWINGS

FIG. 1 schematically illustrates the configuration of a pixel circuit in an embodiment of this disclosure.

FIG. 2 is a timing chart for illustrating the driving control (emission control) of a micro-LED in one frame period.

FIG. 3 illustrates a relation among a control signal PWM_CNTL, ramp voltage VSWEEP, and gray-level data voltage PWM_DATA.

FIG. 4 schematically illustrates the waveform of lighting current in the pixel circuit illustrated in FIG. 1 and the waveform of lighting current in a circuit configured by removing the bypass switch from the foregoing pixel circuit.

FIG. 5 illustrates a detailed configuration example of a pixel circuit.

FIG. 6A is a sequence diagram illustrating temporal variation in one frame of signals in a pixel circuit.

FIG. 6B indicates the specifics of the signal waveforms in two of the graphs in FIG. 6A.

FIG. 7 is a graph providing examples of the waveforms of lighting current for different gray levels.

FIG. 8 is a graph for explaining the difference in the waveform of lighting current between a related art and an embodiment of this disclosure.

FIG. 9 is a timing chart for illustrating the driving control (emission control) of a micro-LED in one frame period in Embodiment 2.

FIG. 10 illustrates a circuit configuration example of a pixel circuit in an embodiment of this disclosure to enable the timing chart of FIG. 9.

FIG. 11 is a diagram for illustrating variation of the waveform of the lighting current caused by variation in the threshold voltage Vth of the bypass switch of an n-type thin-film transistor.

FIG. 12A is a graph indicating the relation between the threshold voltage Vth of the bypass switch and the time lag (T2-T1) in the graph in FIG. 11.

FIG. 12B is a graph indicating the relation between the control voltage VBG for the bypass switch and the threshold voltage Vth of the bypass switch.

FIG. 13 illustrates a circuit configuration example of a pixel circuit in Embodiment 3.

FIG. 14 provides temporal variation of some signals in a pixel circuit in Embodiment 3.

FIG. 15 is a plan diagram illustrating a configuration example of a micro-LED display device.

FIG. 16 is a perspective diagram schematically illustrating the display region of a micro-LED display device.

### EMBODIMENTS

An aspect of this disclosure describes a pixel circuit for controlling light emission of a micro-light-emitting diode (micro-LED). The pixel circuit lights the micro-LED for an emission period having a length in accordance with gray-level data and keeps the micro-LED from lighting in the other period in one frame period. A longer emission period means higher brightness of the light from the micro-LED.

An embodiment of this disclosure controls the emission period (brightness) of a micro-LED by pulse width modulation (PWM) in accordance with gray-level data. The method of driving a micro-LED by PWM control (PWM driving) supplies pulsed driving current (also referred to as lighting current or LED current) having a pulse width in accordance with gray-level data to the micro-LED to light the micro-LED. The pulse width is a length between the medians in the rise and the fall of a pulse of the driving current; a longer pulse width means a longer emission period or higher brightness. The driving current for a low gray-level range does not reach the highest value for a high gray level; its waveform may consist of a steep rising edge and a gentle falling edge.

The analog PWM driving requires a rectangular waveform for the ideal driving current. However, the current by the actual circuit does not fall instantly; a finite falling time (transition region) exists where the driving current value decreases little by little. During the falling time, the driving current gradually decreases.

The emission wavelength of a micro-LED shifts to a shorter wavelength with increase in density of the driving current and then, shifts toward a longer wavelength with further increase. The external quantum efficiency (EQE) of a micro-LED significantly degrades when the driving current density is low. Especially in the case where the supply period of the driving current for a low gray-level only consists of a falling time, the adverse effect onto the emission of the micro-LED is high. Accordingly, reducing this falling time is a major issue in the PWM driving of a micro-LED.

A pixel circuit in an aspect of this disclosure includes a constant current circuit, a PWM circuit, a current control switch, and a bypass switch. The constant current circuit generates a constant current. The PWM circuit generates a pulse signal from gray-level data. For example, the PWM circuit compares a gray-level data voltage representing the gray-level data with a ramp voltage to generate the pulse signal. The current control switch turns ON/OFF the current flowing from the constant current circuit to the micro-LED in accordance with the pulse signal from the PWM circuit.

The bypass switch is turned ON/OFF on a bypass path between the anode and the cathode of the micro-LED. When the bypass switch is ON, the anode and the cathode of the micro-LED is electrically connected outside the micro-LED. When the bypass switch is OFF, the anode and the cathode is electrically disconnected outside the micro-LED.

The pixel circuit controls ON/OFF of the bypass switch and the current control switch with a control signal (PWM_CNTL) output from the PWM circuit. The gentle falling of the lighting current occurs because the transition from ON to OFF of the current control switch is gentle. One reason for this is that the transition time of the PWM_CNTL signal is long. The bypass switch enables bypassing the path of the current from the constant current circuit that passes through the gently turning current control switch, so that the lighting current flowing in the micro-LED can be cut off quickly.

### Embodiment 1

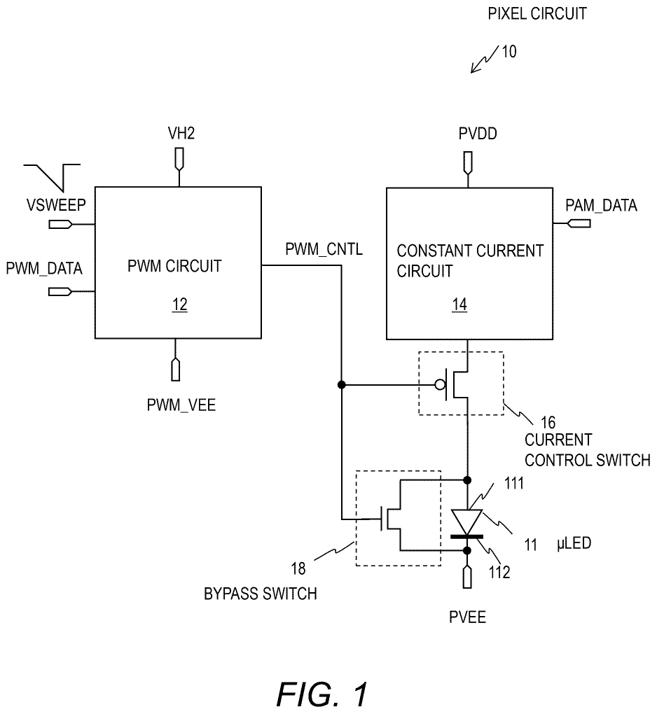

FIG. 1 schematically illustrates the configuration of a pixel circuit in an embodiment of this disclosure. The display region of a display device includes a plurality of pixel circuits 10 arrayed in a predetermined layout, for example, in a matrix. Each pixel circuit 10 includes a micro-LED (μLED) 11, a constant current circuit 14, a PWM circuit 12, a current control switch 16, and a bypass switch 18. The micro-LEDs 11 in all pixel circuits 10 may be for the same color of light or the display region can include micro-LEDs (pixels) 11 for different colors of light, for example, red light, blue light, and green light. The pixels for different colors of light can be also referred to as subpixels.

A micro-LED 11 includes an anode 111 and a cathode 112. The cathode 112 of the micro-LED 11 is supplied with a constant power-supply voltage PVEE. The constant current circuit 14 and the PWM circuit 12 can have any internal configurations.

The constant current circuit 14 generates a constant current. The current control switch 16 is provided between the constant current circuit 14 and the micro-LED 11. The current control switch 16 is a thin-film transistor and in the configuration example of FIG. 1, it is a p-type thin-film transistor. The active layer of the p-type thin-film transistor can be made of low-temperature polysilicon, for example.

In the configuration example of FIG. 1, the source of the current control switch 16 is connected to a terminal of the constant current circuit 14 and the drain is connected to the anode 111 of the micro-LED . The current control switch 16 is disposed on the path of the current that flows from the constant current circuit 14 to the power line for supplying a power-supply voltage PVEE via the micro-LED 11 and turns ON/OFF the path.

The current control switch 16 can be disposed between the micro-LED 11 and the power line for supplying the power-supply voltage PVEE. The current control switch 16 can be an n-type thin-film transistor.

The bypass switch 18 is disposed on a bypass path between the anode 111 and the cathode 112 of the micro-LED 11. In the configuration example of FIG. 1, the bypass switch 18 is an n-type thin-film transistor; the drain is connected to the anode 111 of the micro-LED 11 and the source is connected to the cathode 112 of the micro-LED 11. The active layer of an n-type thin-film transistor can be made of oxide semiconductor or low-temperature polysilicon. The source of the bypass switch 18 can be connected to a given negative power source other than the cathode 112.

The bypass switch 18 is turned ON/OFF on the bypass path between the anode 111 and the cathode 112 of the micro-LED 11. When the bypass switch 18 is ON, the anode 111 and the cathode 112 of the micro-LED 11 are electrically connected outside the micro-LED 11. When the bypass switch 18 is OFF, the anode 111 and the cathode 112 are disconnected outside the micro-LED 11.

The constant current circuit 14 has an input terminal for a power-supply voltage PVDD and an input terminal for current value data PAM_DATA indicating the value of the current to be output. The power-supply voltage PVDD is higher than the power-supply voltage PVEE. The output of the current from the constant current circuit 14 is turned ON/OFF by the current control switch 16.

The PWM circuit 12 generates a control signal PWM_CNTL from a gray-level data voltage PWM_DATA and outputs it. The PWM circuit 12 has an input terminal for the gray-level data voltage PWM_DATA and an input terminal for a ramp voltage VSWEEP. The ramp voltage VSWEEP is a voltage (signal) that linearly increases or decreases with time and the gray-level data voltage PWM_DATA is a voltage in accordance with the gray level of a pixel of a video frame.

The PWM circuit 12 further has an input terminal for a power-supply voltage VH2 and an input terminal for a power-supply voltage PWM_VEE. The power-supply voltages VH2 and PWM_VEE respectively correspond to the H-level and the L-level of the control signal PWM_CNTL from the PWM circuit 12. The PWM circuit 12 compares the gray-level data voltage PWM_DATA representing gray-level data with the ramp voltage VSWEEP to generate the control signal PWM_CNTL of a pulse signal.

The current control switch 16 and the bypass switch 18 are turned ON/OFF in accordance with the control signal PWM_CNTL from the PWM circuit 12. In the configuration example of FIG. 1, the path from the PWM circuit 12 to the gate of the current control switch 16 is only composed of wiring; there is no resistive element, capacitive element, or thin-film transistor. In similar, the path from the PWM circuit 12 to the gate of the bypass switch 18 is only composed of wiring; there is no resistive element, capacitive element, or thin-film transistor.

A circuit element (other than a line) can be provided between the output terminal of the PWM circuit 12 and the gate of the current control switch 16 and/or the bypass switch 18. For example, the current control switch 16 and the bypass switch 18 can be thin-film transistors having the opposite polarity (p-type or n-type) and the control signal PWM_CNTL from the PWM circuit 12 can be supplied to the gate of either switch via an inverter. In another configuration example, a delay circuit can be provided between the PWM circuit 12 and the current control switch 16 or bypass switch 18.

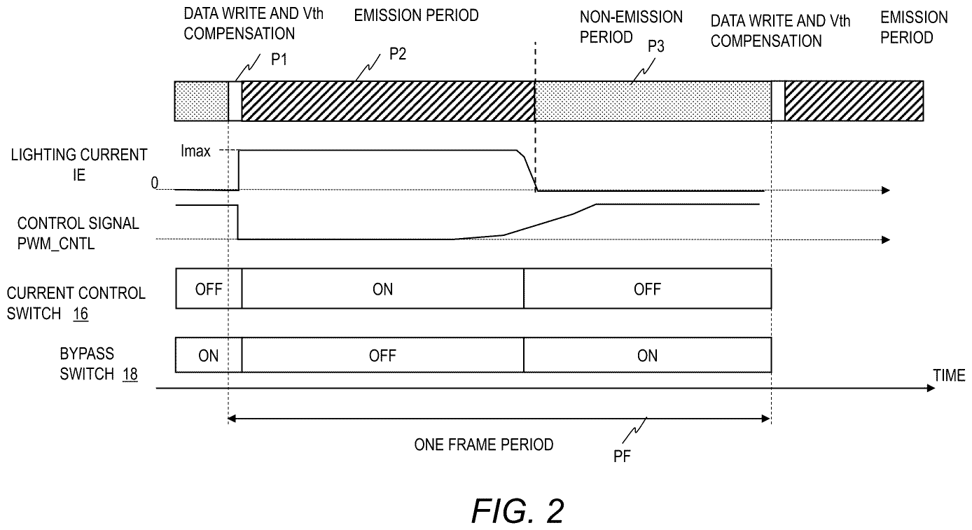

FIG. 2 is a timing chart for illustrating the driving control (emission control) of a micro-LED 11 in one frame period. From the viewpoint of controlling a pixel circuit 10, one frame period PF is separated to three periods. One frame period is a period to display an image of one frame in video data from the external.

In the first period P1, data voltages are written to the pixel circuit 10 and on that occasion, the data voltages are adjusted to meet the threshold voltages Vth of thin-film transistors. Specifically, a Vth-compensated gray-level data voltage PWM_DATA is written to the PWM circuit 12 and a Vth-compensated current value data PAM_DATA is written to the constant current circuit 14.

The second period P2 following the first period P1 is an emission period. In this period, lighting current is supplied to the micro-LED 11 and the micro-LED 11 emits light. The third period P3 following the second period is a non-emission period. In this period, the micro-LED 11 does not emit light. The period P1 is also a non-emission period and the light emission of the micro-LED 11 is stopped. When the emission period is longer, the brightness of the micro-LED 11 becomes higher.

The lighting current IE that flows from the constant current circuit 14 into the micro-LED 11 has a predetermined maximum current value Imax and has a waveform of a high-level pulse in relation to a low level of the reference level. The maximum current value Imax is specified by the current value data PAM_DATA.

As illustrated in FIG. 2, the shape of a pulse of the lighting current IE has a steep rising edge (leading edge) and a gentle falling edge (trailing edge) that varies gentler than the rising edge. The time of the rising edge (at a specific point thereof) corresponds to the start time of the emission period P2 and the time when the lighting current IE becomes almost zero corresponds to the end time of the emission period P2. The gradient of an edge can be defined by the gradient at the inflection point.

With reference to the pixel circuit 10 in FIG. 1, the lighting current IE is controlled by the current control switch 16 and the bypass switch 18. The current control switch 16 and the bypass switch 18 are controlled to be ON/OFF by the control signal PWM_CNTL from the PWM circuit 12. In the configuration example illustrated in FIGS. 1 and 2, the current control switch 16 and the bypass switch 18 are controlled synchronously.

Moreover, the current control switch 16 and the bypass switch 18 in this configuration example are supplied with the same control signal PWM_CNTL and they are controlled to be ON/OFF mutually exclusively (contradictorily). In other words, when either the current control switch 16 or the bypass switch 18 is ON, the other switch is OFF; when either one is OFF, the other one is ON. These switches switch between ON and OFF simultaneously. The times of switching of the current control switch 16 and the bypass switch 18 almost coincide with the start time and the end time of an emission period.

The example of the control signal PWM_CNTL in FIG. 2 has a waveform of a low-level pulse in relation to a high level of the reference level. The shape of a pulse of the control signal PWM_CNTL has a steep falling edge (leading edge) and a gentle rising edge (trailing edge) that varies gentler than the falling edge. The trailing edge of the control signal PWM_CNTL can be gentler than the trailing edge of the lighting current IE.

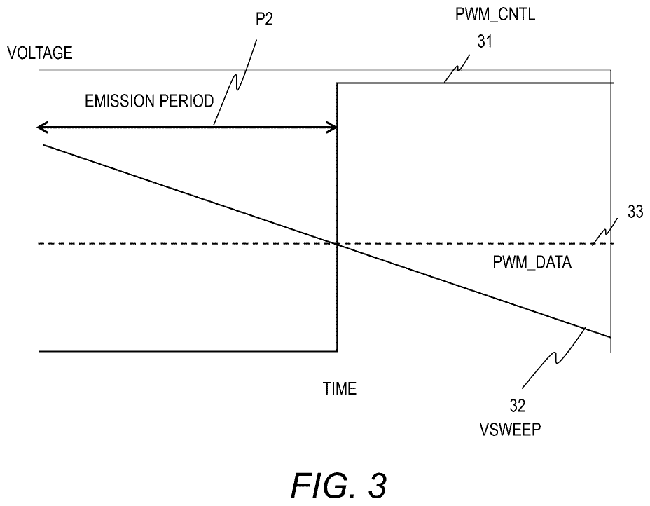

The principle of controlling the pulse width of the control signal PWM_CNTL with the gray-level data voltage PWM_DATA corresponding to a gray level is described. FIG. 3 illustrates the relation among the control signal PWM_CNTL 31, the ramp voltage VSWEEP 32, and the gray-level data voltage PWM_DATA 33. In the graph of FIG. 3, the horizontal axis represents the time and the vertical axis represents the voltage. Although the control signal PWM_CNTL 31 in FIG. 3 has an ideal waveform, the actual waveform has a gentle rising edge as illustrated in FIG. 2.

The ramp voltage VSWEEP 32 linearly decreases from the beginning of an emission period P2. In another example, the ramp voltage can increase linearly. For the gray-level data voltage PWM_DATA 33, predetermined voltages are assigned to individual gray levels and each voltage assigned to a gray level is a constant voltage. A lower gray-level data voltage PWM_DATA 33 corresponds to a higher gray level. The intersection between the ramp voltage VSWEEP 32 and the gray-level data voltage PWM_DATA 33 coincides with the rising edge of the control signal PWM_CNTL 31. In this way, the PWM circuit 12 generates the control signal PWM_CNTL from the gray-level data voltage PWM_DATA, using the input ramp voltage VSWEEP.

As described with reference to FIGS. 1 and 2, the pixel circuit 10 includes the bypass switch 18 in addition to the current control switch 16. The bypass switch 18 works to sharpen the falling edge of the lighting current IE.

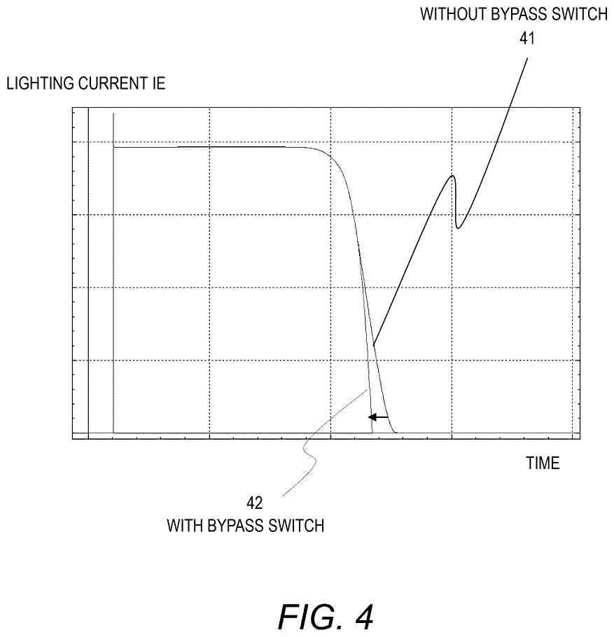

FIG. 4 schematically illustrates the waveform of lighting current IE in the pixel circuit 10 illustrated in FIG. 1 and the waveform of lighting current in a circuit configured by removing the bypass switch 18 from the pixel circuit 10. In the graph of FIG. 4, the horizontal axis represents the time and the vertical axis represents the current value. The curve 41 is the waveform of the lighting current in the circuit configured by removing the bypass switch 18 from the pixel circuit 10. The curve 42 is the waveform of the lighting current IE in the pixel circuit 10 in FIG. 1.

As described above, a bypass switch 18 is connected between the anode and the cathode of the micro-LED 11 and the bypass switch 18 and the current control switch 16 are controlled to be ON/OFF by the output (PWM_CNTL) of the PWM circuit 12. Moreover, the ON/OFF of the bypass switch 18 and the current control switch 16 are mutually exclusively driven.

One cause of the gentle falling of the lighting current shown in the curve 41 is slow transition from an ON state to an OFF state of the current control switch 16. This is because the transition time of the control signal PWM_CNTL from the PWM circuit 12 is long, as described with reference to FIG. 2.

As understood from the comparison of the waveforms 42 and 41 in FIG. 4, the bypass switch 18 expedites cutting off the lighting current flowing in the micro-LED 11 by bypassing the gently varying current from the current control switch 16.

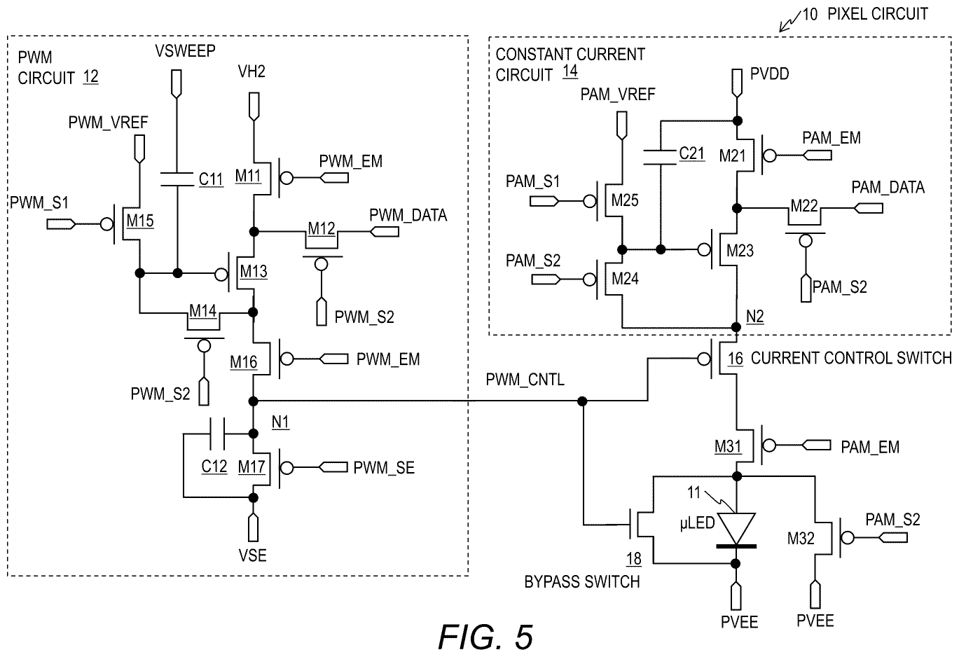

FIG. 5 illustrates a detailed configuration example of a pixel circuit 10. The PWM circuit 12 consists of seven thin-film transistors (also simply referred to as transistor) and two capacitive elements. The constant current circuit 14 consists of five thin-film transistors and one capacitive element. The two circuits 12 and 14 can include any number of transistors and capacitors; the number can be either the same or different between the two circuits 12 and 14. These circuits can include other kinds of circuit elements such as resistive elements.

The PWM circuit 12 in FIG. 5 includes transistors M11 to M17 and capacitors C11 and C12. The transistors M11 to M17 are p-type thin-film transistors and they are switching transistors.

The source of the transistor M11 is supplied with a power-supply voltage VH2 and the drain is connected to the source of the transistor M13 and one source/drain of the transistor M12. The source and the drain of a transistor interchange depending on the direction of the current flow. The term “source/drain” means either the source or the drain. The gate of the transistor M11 is supplied with a control signal PWM_EM.

The gate of the transistor M12 is supplied with a scanning signal PWM_S2. One source/drain of the transistor M12 is connected to the drain of the transistor M11 and the source of the transistor M13; the other source/drain of the transistor M12 is supplied with the gray-level data voltage PWM_DATA.

The gate of the transistor M13 is connected to one end of the capacitor C11, a source/drain of the transistor M14, and a source/drain of the transistor M15. The other end of the capacitor C11 is supplied with the ramp voltage VSWEEP. The source of the transistor M13 is connected to the drain of the transistor M11 and one source/drain of the transistor M12. The drain of the transistor M13 is connected to the other source/drain of the transistor M14 and the source of the transistor M16.

The gate of the transistor M14 is supplied with the scanning signal PWM_S2. One source/drain of the transistor M14 is connected to the drain of the transistor M13 and the source of the transistor M16 and the other source/drain of the transistor M14 is connected to the gate of the transistor M13 and a source/drain of the transistor M15.

The gate of the transistor M15 is supplied with a scanning signal PWM_S1. One source/drain of the transistor M15 is connected to the gate of the transistor M13 and a source/drain of the transistor M14. The other source/drain of the transistor M15 is supplied with a constant reference voltage PWM_VREF.

The gate of the transistor M16 is supplied with the control signal PWM_EM. The drain of the transistor M16 is connected to the source of the transistor M17. The control signal PWM_CNTL is output from a node N1 between the transistors M16 and M17.

The gate of the transistor M17 is supplied with a control signal PWM_SE. The drain of the transistor M17 is supplied with a constant negative potential VSE. The capacitor C12 is connected between the source and drain of the transistor M17. The control signal PWM_SE turns to a low level before the gray-level data voltage PWM_DATA is written, turning ON the transistor M17 and setting the potential of node N1 at VSE. The capacitor C12 has a function to hold the potential of the node N1.

The gray-level data voltage PWM_DATA is written to the capacitor C11 via the transistors M12, M13, and M14. Subsequently, the falling ramp voltage VSWEEP is supplied to the capacitor C11 and until the gate voltage of the transistor M13 becomes equal to the voltage VH2-Vth, the transistor M13 is kept OFF. During this period, the potential at the node N1 is kept at VSE by the capacitor C12. When the gate voltage of the transistor M13 becomes lower than VH2-Vth, the transistor M13 turns ON to output VH2 to the node N1, so that the control signal PWM_CNTL of a pulse is output. The principle of this operation is the same as the principle of the control signal PWM_CNTL that changes depending on the difference between the gray-level data voltage PWM_DATA and the ramp voltage VSWEEP, which has been described with reference to FIG. 3.

The constant current circuit 14 includes transistors M21 to M25 and a capacitor C21. The transistors M21 to M25 are p-type transistors and the transistors except for the transistor M23 are switching transistors.

The gate of the transistor M21 is supplied with a control signal PAM_EM. The source of the transistor M21 is supplied with a constant power-supply voltage PVDD and the drain is connected to a source/drain of the transistor M22 and the source of the transistor M23.

The gate of the transistor M22 is supplied with a scanning signal PAM_S2. The other source/drain of the transistor M22 is supplied with current value data PAM_DATA.

The gate of the transistor M23 is connected to the capacitor C21, a source/drain of the transistor M24, and a source/drain of the transistor M25. The drain of the transistor M23 is connected to an output node N2 of the constant current circuit 14.

The gate of the transistor M24 is supplied with the scanning signal PAM_S2. A source/drain of the transistor M24 is connected to the output node N2 of the constant current circuit 14 and the other source/drain is connected to the gate of the transistor M23, the capacitor C21, and a source/drain of the transistor M25.

The gate of the transistor M25 is supplied with a scanning signal PAM_S1. A source/drain of the transistor M25 is supplied with a constant reference voltage PAM_VREF and the other source/drain is connected to the gate of the transistor M23, the capacitor C21, and a source/drain of the transistor M24.

The current value data PAM_DATA is written to the capacitor C21 via the transistor M22, M23, and M24. The transistor M23 outputs a current in accordance with the voltage of the capacitor C21 to the output node N2.

The current control switch 16 is a p-type transistor; its source is connected to the output node N2 of the constant current circuit 14 and the drain is connected to the source of the transistor M31. The gate of the current control switch 16 is supplied with the control signal PWM_CNTL from the PWM circuit 12.

A p-type transistor M31 is connected between the anode of the micro-LED 11 and the current control switch 16. The transistor M31 is a switch and its gate is supplied with the control signal PAM_EM. The source is connected to the drain of the current control switch 16 and the drain is connected to the anode of the micro-LED 11.

The transistor M32 is a switch; its gate is supplied with the scanning signal PAM_S2. The transistor M32 is a p-type transistor; the source of the transistor M32 is connected to the anode of the micro-LED 11 and the drain is supplied with a constant power-supply potential PVEE.

The bypass switch 18 is an n-type transistor; its source and drain are respectively connected to the cathode and the anode of the micro-LED 11. The gate of the bypass switch 18 is supplied with the control signal PWM_CNTL from the PWM circuit 12.

The current control switch 16 is configured of a p-type transistor and the bypass switch 18 is configured of the opposite n-type transistor. For this reason, the current control switch 16 and the bypass switch 18 are turned ON/OFF exclusively by the control signal PWM_CNTL. The bypass switch 18 and the transistor M32 both have a function to reset the anode of the micro-LED 11. Accordingly, the transistor M32 can be excluded.

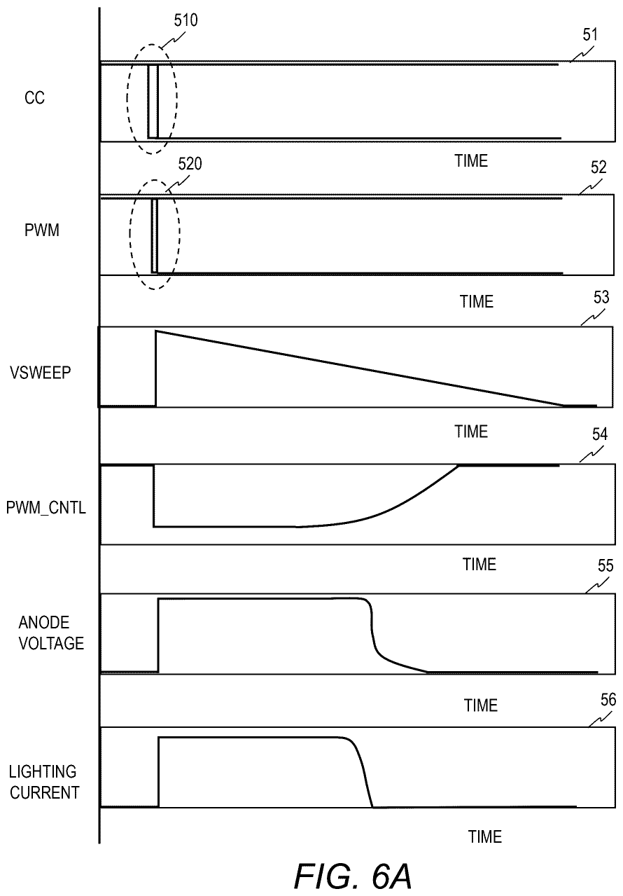

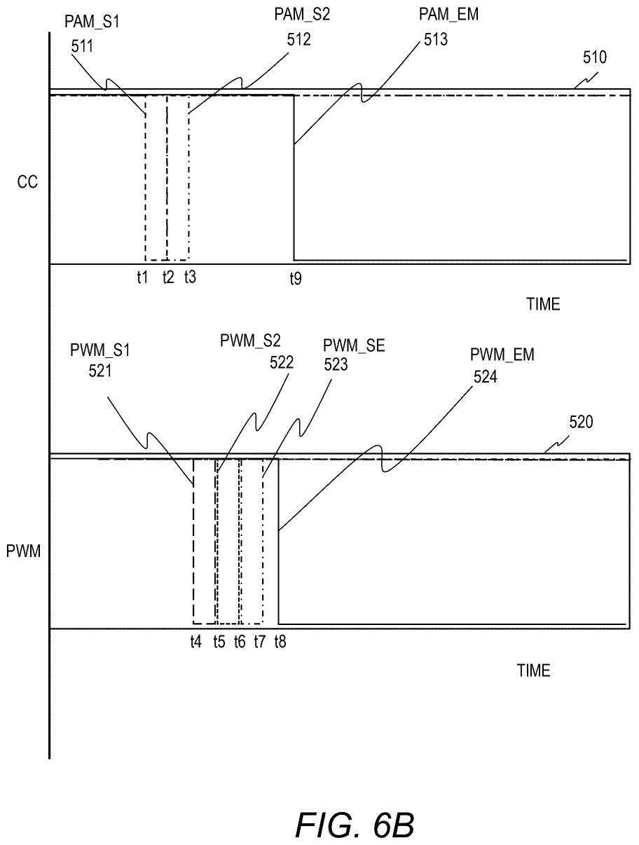

FIG. 6A is a sequence diagram illustrating temporal variation in one frame of signals in a pixel circuit 10. The horizontal axes of the graphs 51 to 56 represent the time and the vertical axes represent the voltage or the current. The graph 51 indicates the temporal variation of the control signals (CC) for the constant current circuit 14. The graph 52 indicates the temporal variation of the control signals (PWM) for the PWM circuit 12. In FIG. 6A, each of the graphs 51 and 52 schematically illustrates temporal variation of a plurality of controls signals. The specifics of the signals in the period surrounded by the broken line 510 in the graph 51 and the period surrounded by the broken line 520 in the graph 52 are provided in FIG. 6B.

The graph 53 indicates the temporal variation of the ramp voltage VSWEEP input to the PWM circuit 12. The graph 54 indicates the temporal variation of the control signal PWM_CNTL output from the PWM circuit 12. The graph 55 indicates the temporal variation of the anode voltage of the micro-LED 11. The graph 56 indicates the temporal variation of the driving current (lighting current) for the micro-LED 11.

FIG. 6B provides temporal variation of the signals in the period surrounded by the broken line 510 in the graph 51 and temporal variation of the signals in the period surrounded by the broken line 520 in the graph 52. The horizontal axes of the graphs 510 and 520 represent the time and the vertical axes represent the voltage of the signals.

The graph 510 indicates the temporal variation of the control signals (CC) for the constant current circuit 14. In the graph 510, the line 511 indicates the temporal variation of the signal PAM_S1; the line 512 indicates the temporal variation of the signal PAM_S2; and the line 513 indicates the temporal variation of the signal PAM_EM.

The signal PAM_S1 (line 511) is a pulse signal that changes from a high level to a low level at a time t1 and changes from the low level to the high level at a time t2. The signal PAM_S2 (line 512) is a pulse signal that changes from a high level to a low level at the time t2 and returns from the low level to the high level at a time t3. The signal PAM_EM (line 513) is a pulse signal that changes from a high level to a low level at a time t9 and changes from the low level to the high level at a not-shown predetermined time in the frame period. In an example, the pulse widths of the signals PAM_S1 and PAM_S2 are one horizontal period.

The graph 520 indicates the temporal variation of the control signals (PWM) for the PWM circuit 12. In the graph 520, the line 521 indicates the temporal variation of the signal PWM_S1; the line 522 indicates the temporal variation of the signal PWM_S2; the line 523 indicates the temporal variation of the signal PWM_SE; and the line 524 indicates the temporal variation of the signal PWM_EM.

The signal PWM_S1 (line 521) is a pulse signal that changes from a high level to a low level at a time t4 and changes from the low level to the high level at a time t5. The signal PWM_S2 (line 522) is a pulse signal that changes from a high level to a low level at the time t5 and returns from the low level to the high level at a time t6. The signal PWM_SE (line 523) is a pulse signal that changes from a high level to a low level at the time t6 and returns from the low level to the high level at a time t7. The signal PWM_EM (line 524) is a pulse signal that changes from a high level to a low level at a time t8 and changes from the low level to the high level at a not-shown predetermined time in the frame period. In an example, the pulse widths of the signals PWM_S1, PWM_S2, and PWM_SE are one horizontal period.

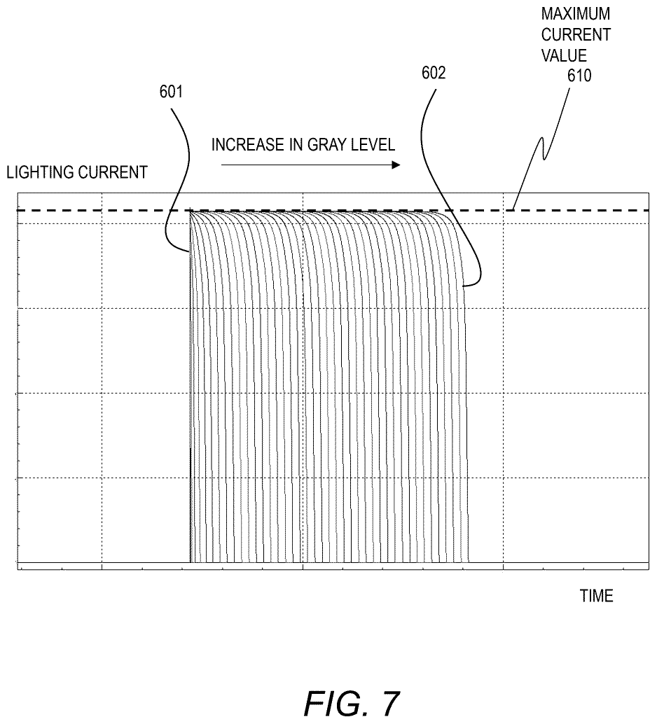

FIG. 7 is a graph providing examples of the waveforms of lighting current for different gray levels. In the graph, the horizontal axis represents the time and the vertical axis represents the amount of the lighting current. The rising edge 601 is common to the waveforms of the lighting current for different gray levels. The curve 602 is the waveform for the maximum gray level 255. The line 610 represents the maximum value of the lighting current for all gray levels.

As the gray level increases, the time from the rising edge 601 to the falling edge becomes longer. The charge amount to be supplied in one frame period increases with increase in gray level. The highest value of the lighting current for some low gray levels may be smaller than this maximum value 610. In other words, the waveforms of the lighting current for those levels can only include a falling edge. For example, the lighting current for a low gray level rises to a value smaller than the maximum value 610 and immediately starts decreasing little by little.

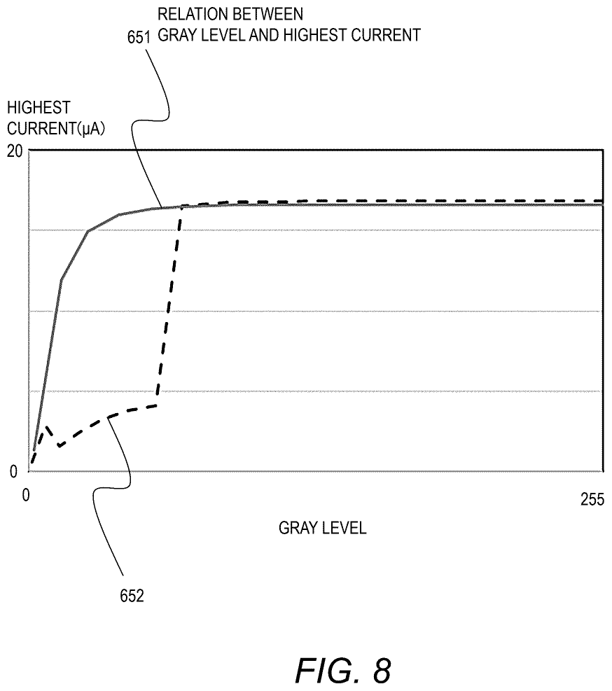

FIG. 8 is a graph for explaining the difference in the waveform of lighting current between a related art and an embodiment of this disclosure. In the graph, the horizontal axis represents the gray level and the vertical axis represents the highest value of the lighting current. The solid line 651 represents the relation between the gray level and the highest value of the lighting current in the pixel circuit 10 including a bypass switch 18 illustrated in FIG. 1. The broken line 652 represents the relation between the gray level and the highest value of the lighting current in a pixel circuit configured by removing the bypass switch 18 from the pixel circuit 10.

Comparison of the two waveforms 651 and 652 indicates that the pixel circuit 10 in an embodiment of this disclosure can keep the maximum current value down to a lower gray level than the pixel circuit of a related art. The lighting current for a low gray level rises to a value lower than the highest value for the high gray levels and then, immediately starts decreasing. The lighting current for a high gray level rises to a predetermined maximum value, keeps the maximum value for a predetermined period, and then starts decreasing along the falling edge.

As described above, the pixel circuit 10 in an embodiment of this disclosure controls the bypass switch 18 with the same control signal PWM_CNTL for the current control switch 16 and turns ON the bypass switch 18 simultaneously with the time to stop the light emission that is different depending on the gray level. The bypass switch 18 makes the lighting current fall steeply to acquire the maximum current value down to a lower gray level.

Embodiment 1 synchronously controls the current control switch and the bypass switch with control signals based on the control signal PWM_CNTL from the PWM circuit 12. Embodiment 1 controls the current control switch 16 and the bypass switch 18 with the same control signal PWM_CNTL. The ON states and the OFF states of the current control switch 16 and the bypass switch 18 are mutually exclusive and the states change simultaneously.

### Embodiment 2

The foregoing embodiment supplies the gates of the current control switch 16 and the bypass switch 18 with the same control signal PWM_CNTL to control ON/OFF of the switches exclusively, as described with reference to FIG. 2, for example. In other words, the foregoing embodiment turns OFF the bypass switch 18 simultaneously with turning ON the current control switch 16 and turns ON the bypass switch 18 simultaneously with turning OFF the current control switch 16.

Another embodiment of this disclosure described in the following turns ON the bypass switch at a time different from the time to turn OFF the current control switch. Specifically, the embodiment turns ON the bypass switch before turning OFF the current control switch. This configuration makes the lighting current fall more steeply. However, this disclosure does not exclude the design that turns ON the bypass switch after turning OFF the current control switch.

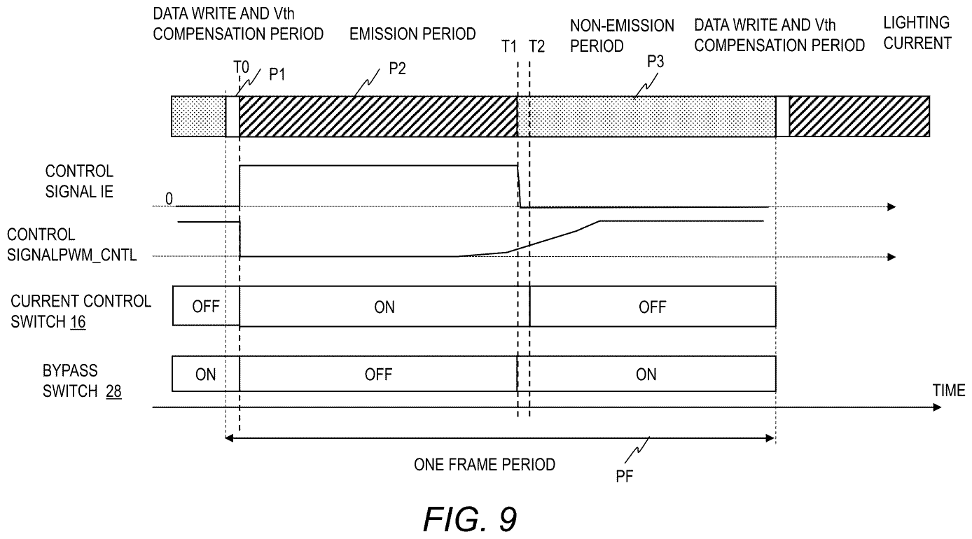

FIG. 9 is a timing chart for illustrating the driving control (emission control) of a micro-LED 11 in one frame period. Differences from the timing chart of FIG. 2 are mainly described. Unless stated otherwise, the description about FIG. 2 is applicable.

In the timing chart of FIG. 2, the time to turn ON the bypass switch 18 is the same as the time to turn OFF the current control switch 16. In the timing chart of FIG. 9, the time T1 to turn ON the bypass switch 28 is different from the time T2 to turn OFF the current control switch 16.

Specifically, the time T1 to turn ON the bypass switch 28 is prior to the time T2 to turn OFF the current control switch 16. This control increases the rate of the bypassed current. As a result, the lighting current falls steeper to make its waveform closer to the ideal rectangular one. Incidentally, the falling edge of the control signal PWM_CNTL in the timing chart of FIG. 9 is substantially vertical and therefore, the time to turn ON the current control switch 16 and the time to turn OFF the bypass switch 28 is the same time T0 (substantially).

The control timing of the current control switch 16 and the bypass switch 28 in FIG. 9 can be realized by increasing the current driving efficiency of the bypass switch 28. The current driving efficiency of the bypass switch 28 can be increased by lowering the absolute value of the threshold voltage Vth or increasing the channel width of the thin-film transistor used as the bypass switch 28.

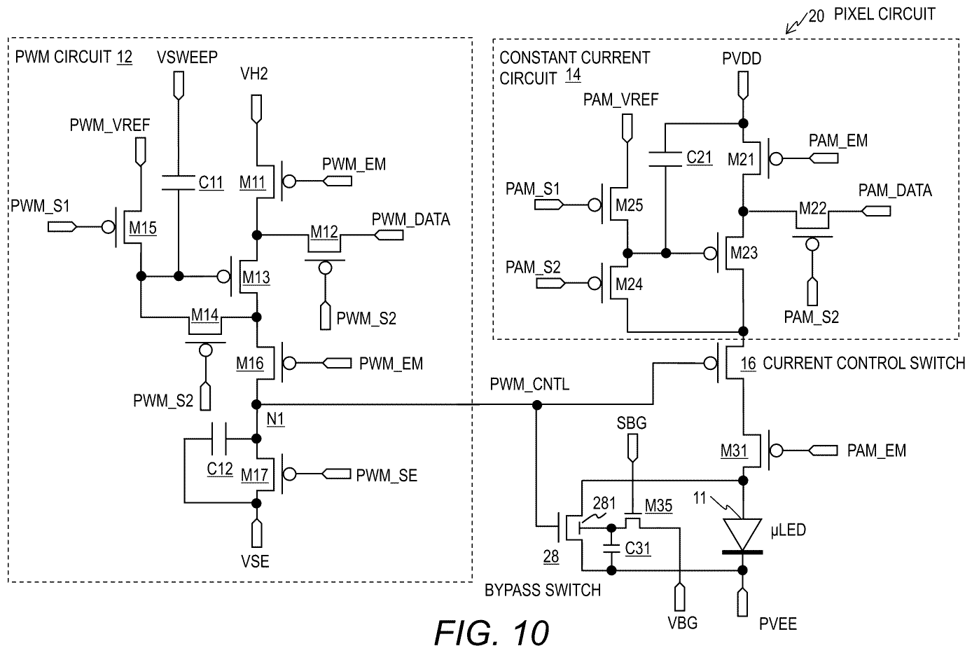

Hereinafter, adjustment of the control timing by adjusting the threshold voltage Vth of the bypass switch 28 is described. FIG. 10 illustrates a circuit configuration example of a pixel circuit 20 in an embodiment of this disclosure to enable the timing chart of FIG. 9. The following mainly describes the differences from the pixel circuit 10 in FIG. 5. Unless stated otherwise, the description about FIG. 5 is applicable.

The pixel circuit 20 includes a bypass switch 28 having a dual-gate structure in place of the bypass switch 18 in FIG. 5. The dual-gate structure includes a top gate and a bottom gate sandwiching the channel region in the layering direction. One end of a charge storage capacitor C31 is connected to the back gate 281 of the bypass switch 28. The back gate 281 is the top gate or the bottom gate. The other end of the charge storage capacitor C31 is connected to the cathode of the micro-LED 11.

A control voltage VBG is written to the charge storage capacitor C31 and the charge storage capacitor C31 holds the voltage. A switch M35 of an n-type transistor can be ON during the period to write the control voltage VBG to the charge storage capacitor C31 and can be OFF in the other period. The switch M35 is turned ON/OFF by a control signal SBG and the control voltage VGB is written to the charge storage capacitor C31 via the switch M35 in an ON state.

The control voltage VBG is a back-gate bias for the bypass switch 28. The threshold voltage Vth of the bypass switch 28 shifts in response to the back-gate bias. For example, when the back-gate bias for an n-type thin-film transistor is increased positively, the threshold voltage Vth decreases. The display device including the pixel circuit 20 realizes a desired falling edge in the waveform of the lighting current by writing a predetermined optimum control voltage VBG to the charge storage capacitor C31.

In manufacturing the display device, the back-gate bias of each pixel can be individually adjusted to minutely adjust the emission period with assistance of a two-dimensional brightness measurement camera so as to reduce the display unevenness in the display region. Although the pixel circuit 20 does not include the transistor M32, the pixel circuit 20 can include the transistor M32.

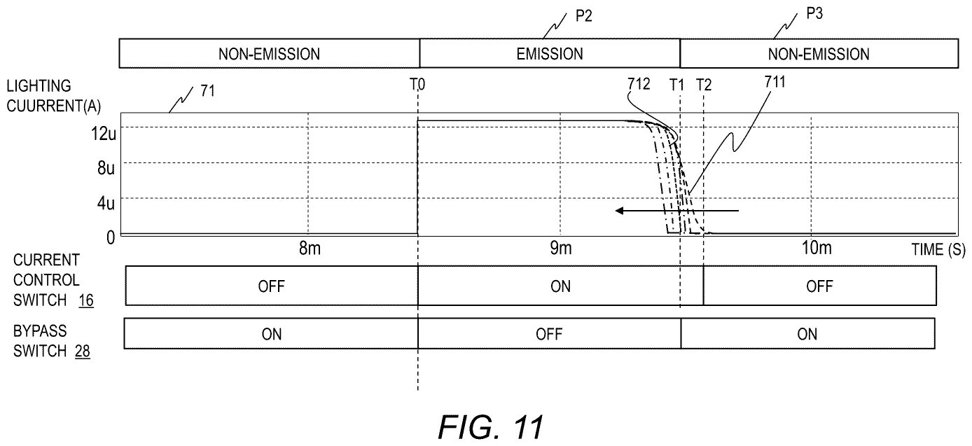

FIG. 11 is a diagram for illustrating variation of the waveform of the lighting current caused by variation in the threshold voltage Vth of the bypass switch 28 of an n-type thin-film transistor. In FIG. 11, the data write period immediately before the emission period P2 is omitted. The time T2 is a time to turn OFF the current control switch 16 and the time T1 is a time to turn ON the bypass switch 28.

The graph 71 indicates temporal variation of the lighting current in pixel circuits 20 whose bypass switches 28 have different threshold voltages Vth. The graph 71 further includes a waveform of the lighting current in a pixel circuit configured by removing the bypass switch 28 from the pixel circuit 20.

In the graph 71, the horizontal axis represents the time and the vertical axis represents the value of the lighting current. The curve 711 is the waveform of the lighting current in the pixel circuit configured by removing the bypass switch 28 from the pixel circuit 20 in FIG. 10. The other curves including the curve 712 are the waveforms of the lighting current in the pixel circuits 20 whose bypass switches 28 have different threshold voltages Vth. The curve 712 is a waveform of the lighting current in response to state changes of the current control switch 16 and the bypass switch 28 in FIG. 11.

The graph 71 indicates the variation in the waveform of the lighting current when the threshold voltage Vth of the bypass switch 28 is shifted from 4.5 V to 0.5 V. As the threshold voltage Vth decreases, the time T1 comes earlier. That is to say, the time lag between the time T2 and the time T1 increases. As a result, the time when the lighting current starts falling gets earlier with decrease in threshold voltage Vth. In addition, the gradient of the falling edge of the lighting current becomes steeper with decrease in threshold voltage Vth.

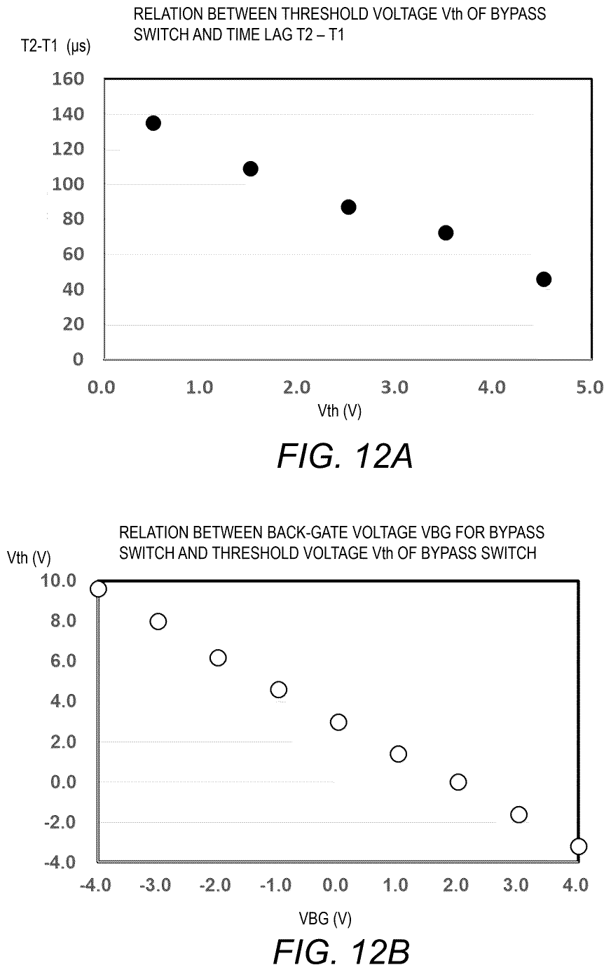

FIG. 12A is a graph indicating the relation between the threshold voltage Vth of the bypass switch 28 and the time lag (T2-T1) in the graph 71 in FIG. 11. FIG. 12B is a graph indicating the relation between the control voltage VBG (back-gate bias) for the bypass switch 28 and the threshold voltage Vth of the bypass switch 28. As indicated in FIG. 12A, the time lag (T2-T1) increases with decrease in threshold voltage Vth of the bypass switch 28. In other words, the time T1 gets earlier. As indicated in FIG. 12B, the threshold voltage Vth decreases with increase in back-gate bias. Note that the relation between the threshold voltage Vth and the time lag (T2-T1) and the relation between the back-gate bias and the threshold voltage Vth in a p-type thin-film transistor are opposite to those in an n-type thin-film transistor.

The synchronized control of the current control switch and the bypass switch is common to Embodiment 1 and Embodiment 2. Specifically, the time lag between the time to turn ON the bypass switch and the time to turn OFF the current control switch is fixed (including 0) and the time lag between the time to turn OFF the bypass switch and the time to turn ON the current control switch is fixed (including 0). Embodiment 1 and Embodiment 2 both turn ON the bypass switch before (including simultaneously with) turning OFF the current control switch.

The current control switch can have a dual-gate structure, instead of the bypass switch. The time to turn OFF the current control switch can be adjusted by the threshold voltage of the current control switch. The timing of changing the states of the current control switch and/or the bypass switch can also be adjusted by the circuit configuration, instead of the threshold voltage or channel width of a thin-film transistor.

For example, a delay circuit can be inserted between the output of the PWM circuit 12 and the current control switch 16. The delay circuit delays the change (fall or rise) of the control signal input to the current control switch relative to the change of the control signal input to the bypass switch. The signal from the delay circuit is a control signal based on the control signal PWM_CNTL. With reference to the example of FIG. 11, the current control switch turns ON to start the emission period P2 after the bypass switch turns OFF. Subsequently, the current control switch turns OFF after the bypass switch turns ON.

As described above, Embodiment 2 synchronously controls the current control switch 16 and the bypass switch 28 with the control signals based on the control signal PWM_CNTL from the PWM circuit 12. The synchronous control of Embodiment 2 turns ON the bypass switch 28 and turns OFF the current control switch 16 at different times to end an emission period.

More specifically, Embodiment 2 turns OFF the current control switch 16 after turning ON the bypass switch 28. The current control switch 16 and the bypass switch 28 can be supplied with the same control signal PWM_CNTL and their control timing can be adjusted with the threshold voltage of the bypass switch 28, for example.

### Embodiment 3

Embodiment 3 configures all thin-film transistors in a pixel circuit of the same conductive type of thin-film transistors. This configuration simplifies the manufacturing process. In the configuration example of a pixel circuit described in the following, all thin-film transistors are p-type thin-film transistors. All thin-film transistors can be n-type thin-film transistors.

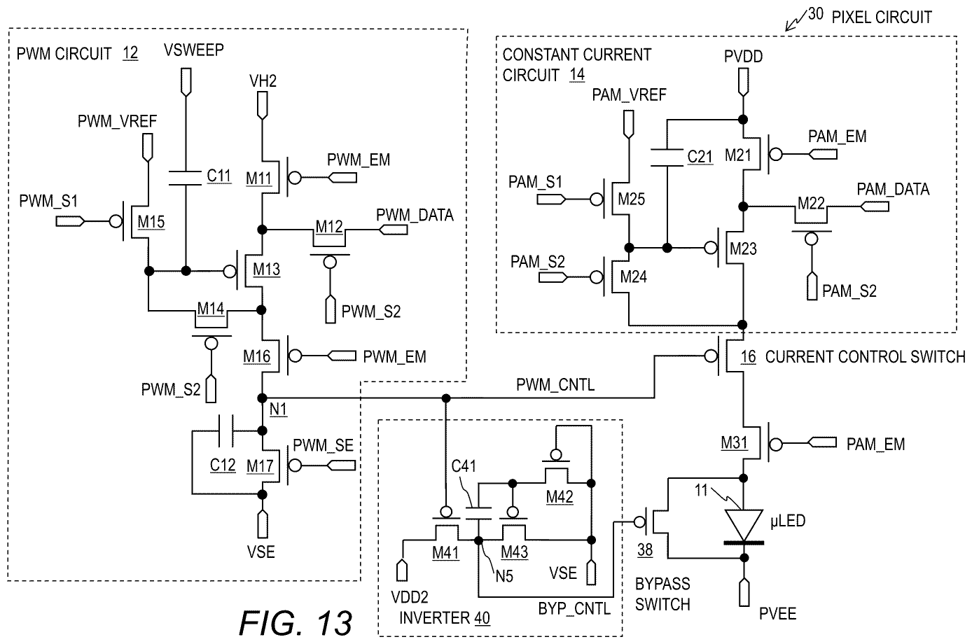

FIG. 13 illustrates a circuit configuration example of a pixel circuit 30 in an embodiment of this disclosure. The following mainly describes differences from the pixel circuit 10 illustrated in FIG. 5. Unless stated otherwise, the description about FIG. 5 is applicable.

In the pixel circuit 30, the bypass switch 38 is a p-type thin-film transistor. The pixel circuit 30 includes an inverter 40 for generating a control signal BYP_CNTL for the bypass switch 38. The inverter 40 generates the control signal BYP_CNTL from the control signal PWM_CNTL from the PWM circuit 12. The control signal BYP_CNTL is supplied to the gate of the bypass switch 38. The control signal BYP_CNTL is a signal whose polarity is inverted with respect to the control signal PWM_CNTL.

The inverter 40 includes transistors M41, M42, and M43 of switches. These are p-type thin-film transistors. The inverter 40 further includes a capacitor C41. The control signal PWM_CNTL is supplied to the gate of the transistor M41. The source of the transistor M41 is supplied with a constant power-supply voltage VDD2 and the drain is connected to an output node N5. The output node N5 is connected to the gate of the bypass switch 38 to supply the control signal BYP_CNTL to the gate of the bypass switch 38.

The drain of the transistor M42, which is diode-connected, is supplied with a constant potential (negative potential) VSE and the source is connected to the gate of the transistor M43. The drain of the transistor M43 is supplied with the constant potential VSE and the source is connected to the output node N5. One end of the capacitor C41 is connected to the gate of the transistor M43 and the other end is connected to the output node N5. The potential (voltage) VSE can be the same as the potential VSE for the PWM circuit 12. The power-supply voltage VDD2 can be the same as the potential VH2 for the PWM circuit 12 or the potential PVDD for the constant current circuit 14 but it is convenient that the potential VDD2 is a different power-supply voltage to allow independent adjustment for the reasons to be described later.

Although the pixel circuit 30 does not include the transistor M32, the pixel circuit 30 can include the transistor M32. The configurations of the PWM circuit 12 and the constant current circuit 14 are the same as those in the pixel circuit 10 in FIG. 5. The current control switch 16 is also a p-type thin-film transistor.

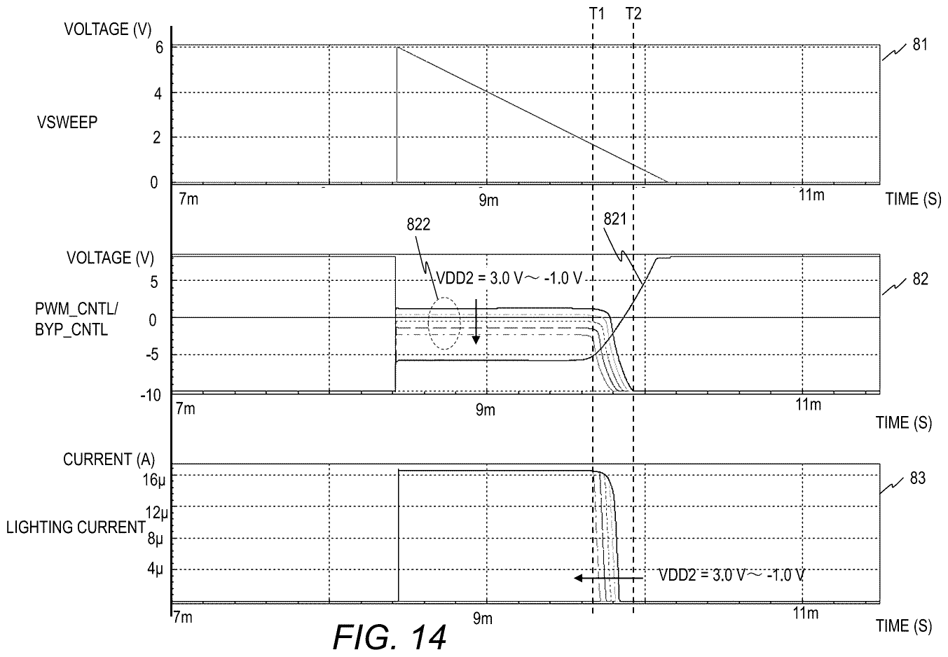

FIG. 14 provides temporal variation of some signals in the pixel circuit 30. The graph 81 indicates the temporal variation of the ramp voltage VSWEEP. The horizontal axis represents the time and the vertical axis represents the voltage. The graph 82 indicates the temporal variation of the control signals PWM_CNTL and BYP_CNTL. The horizontal axis represents the time and the vertical axis represents the voltage. The curve 821 is the waveform of the control signal PWM_CNTL. The curves surrounded by a broken line 822 are the waveforms of the control signal BYP_CNTL under different power-supply voltages VDD2. The graph 83 indicates the temporal variation of the lighting current. The horizontal axis represents the time and the vertical axis represents the current. The graph 83 provides the waveforms of lighting current under different power-supply voltages VDD2.

The time T1 is the time when the bypass switch 38 is turned ON at a specific power-supply voltage VDD2. The time T2 is the time when the current control switch 16 is turned OFF. Like in Embodiment 2, the current control switch 16 is turned OFF after the bypass switch 38 is turned ON. The times T1 and T2 can be the same time, like in Embodiment 1.

The time lag between the times T1 and T2 can be adjusted by changing the value of the voltage VDD2 for the inverter 40 to select the optimum operating condition. For example, the current control switch 16 and the bypass switch 38 can be controlled to satisfy the condition of Time T2>Time T1 by adjusting the power-supply voltage Vdd2 for the inverter 40.

The curves surrounded by a broken line 822 in the graph 82 indicate the variation of the waveform of the control signal BYP_CNTL when the power-supply voltage VDD2 for the inverter 40 is varied from 3.0 V to −1.0 V. As the power-supply voltage VDD2 decreases, the highest potential of the signal BYP_CNTL lowers to shorten the pulse width. For this reason, the time T1 to turn ON the p-type bypass switch 38 gets earlier to reduce the pulse width of the lighting current and increase the gradient of its falling edge as shown in the graph 83.

As described above, Embodiment 3 synchronously controls the current control switch and the bypass switch with the control signals based on the control signal PWM_CNTL from the PWM circuit 12. In Embodiment 3, the gate of the current control switch 16 is supplied with the control signal PWM_CNTL and the gate of the bypass switch 38 is supplied with the inverted signal of the control signal PWM_CNTL.

In other words, control signals based on the control signal PWM_CNTL control the current control switch 16 and the bypass switch 38. The control signals based on

the control signal PWM_CNTL are signals generated from the control signal PWM_CNTL and they can be the control signal PWM_CNTL itself or a control signal different therefrom (such as an inverted signal and delayed signal).

Embodiment 3 synchronously controls the current control switch 16 and the bypass switch 38 with control signals based on the control signal PWM_CNTL from the PWM circuit 12. The synchronized control of Embodiment 3 turns ON the bypass switch 38 and turns OFF the current control switch 16 at different times to end an emission period.

More specifically, Embodiment 3 turns OFF the current control switch 16 after turning ON the bypass switch 38. The control timing of these switches can be adjusted with the power-supply voltage VDD2 for the inverter circuit that generates a control signal for the bypass switch 38 from the control signal PWM_CNTL.

### Embodiment 4

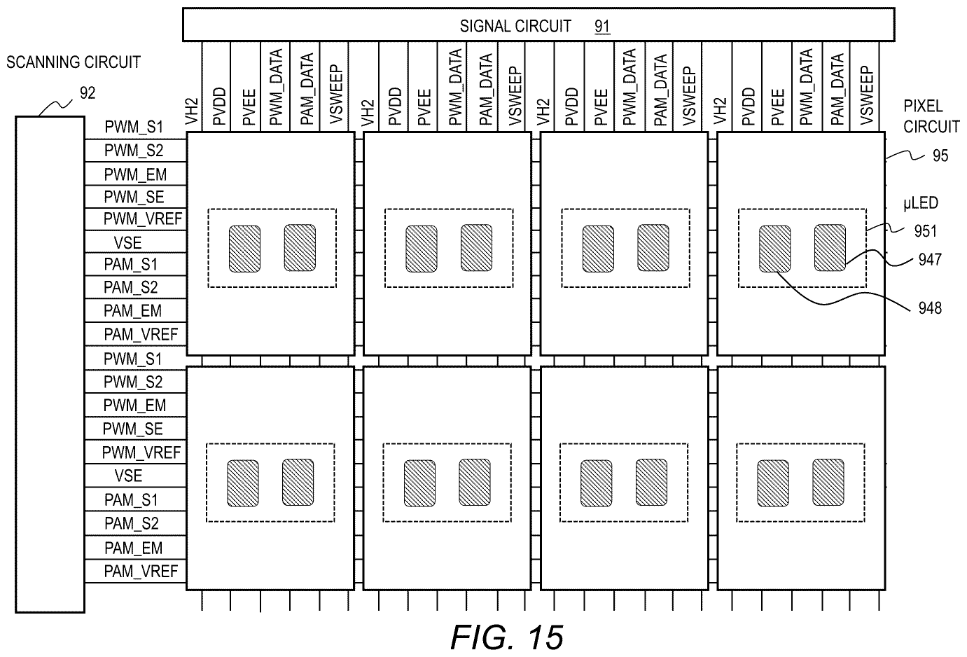

A configuration example of a micro-LED display device that can include the pixel circuits in the foregoing embodiments is described. FIG. 15 is a plan diagram illustrating a configuration example of a micro-LED display device. The micro-LED display device includes a display region including an array of pixel circuits 95 and micro-LEDs 951 and control circuits for controlling the pixel circuits 95 including a signal circuit 91 and a scanning circuit 92. The signal circuit 91 and the scanning circuit 92 supply power-supply voltages (constant voltages) and control signals for controlling the pixel circuits 95. The signal circuit 91 and the scanning circuit 92 are controlled by a not-shown video processing circuit. The video processing circuit is a circuit for processing video data input from the external of the micro-LED display device.

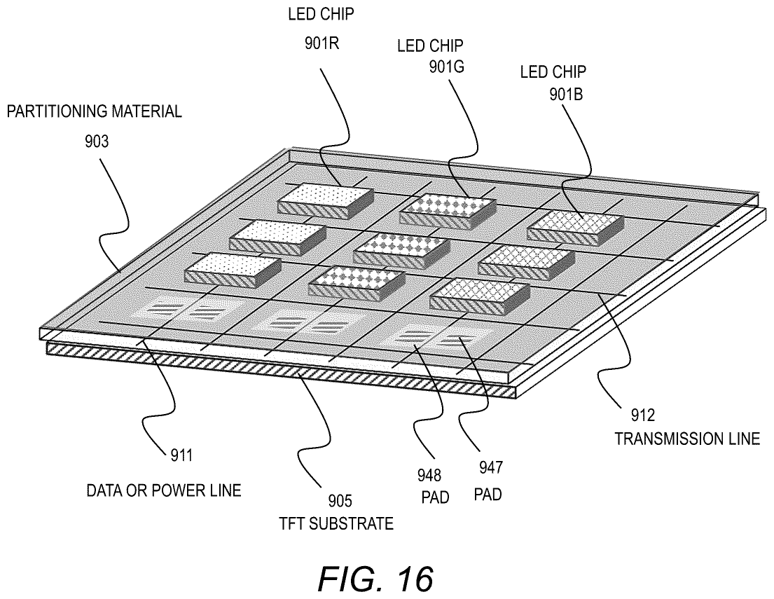

A pixel circuit 95 controls a micro-LED 951. The elements of the pixel circuit 95 is fabricated on a thin-film transistor (TFT) substrate in FIG. 16. The micro-LED 951 is connected to connection pads 947 and 948 on the TFT substrate to be electrically connected to the pixel circuit 95 through the connection pads 947 and 948. For example, the anode and the cathode of a micro-LED 951 are physically and electrically connected to the pads 947 and 948 by soldering.

FIG. 16 is a perspective diagram schematically illustrating the display region of a micro-LED display device. Red LED chips 901R, green LED chips 901G, and blue LED chips 901B are disposed in a matrix on a TFT substrate 905. FIG. 16 also includes data or power lines 911 and transmission lines 912. Pads 947 and 948, which are exposed when the LED chips are removed, are shown for illustration. The regions between the LED chips 901R, 901G, and 901B mounted on the TFT substrate 905 are filled with partitioning material 903. The partitioning material 903 is black material such as black resin to reduce the surface reflectance.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A pixel circuit configured to control light emission of a light-emitting diode, the pixel circuit comprising:
a constant current circuit;
a pulse width modulation circuit;
a current control switching transistor on a path of lighting current that is supplied from the constant current circuit and flows through the light-emitting diode; and
a bypass switching transistor connected to an anode of the light-emitting diode, the bypass switching transistor being configured to be controlled synchronously with the current control switching transistor,
wherein the current control switching transistor is turned ON and then turned OFF by a first pulse signal based on a pulse control-signal from the pulse width modulation circuit and the bypass switching transistor is turned OFF and then turned ON by a second pulse signal based on the pulse control-signal from the pulse width modulation circuit to control an emission period of the light-emitting diode.

2. The pixel circuit according to claim 1, wherein the first pulse signal and the second pulse signal are both the pulse control-signal from the pulse width modulation circuit.

3. The pixel circuit according to claim 1, wherein the bypass switching transistor is turned OFF simultaneously with turning ON of the current control switching transistor and turned ON simultaneously with turning OFF of the current control switching transistor.

4. The pixel circuit according to claim 1, wherein the bypass switching transistor is turned ON before the current control switching transistor is turned OFF.

5. The pixel circuit according to claim 4,
wherein the bypass switching transistor has a dual-gate structure, and
wherein a back gate of the bypass switching transistor is supplied with a voltage to adjust a threshold voltage of the bypass switching transistor.

6. The pixel circuit according to claim 1, wherein the current control switching transistor and the bypass switching transistor are of different conductive types.

7. The pixel circuit according to claim 1,
wherein the current control switching transistor and the bypass switching transistor are of the same conductive type,
wherein one of the first pulse signal and the second pulse signal is the pulse control-signal from the pulse width modulation circuit, and
wherein the other one of the first pulse signal and the second pulse signal is an inverted signal of the pulse control-signal from the pulse width modulation circuit.

8. The pixel circuit according to claim 7, further comprising:
an inverter circuit configured to output the other one of the first pulse signal and the second pulse signal generated from the pulse control-signal from the pulse width modulation circuit,
wherein a time lag between a time to turn OFF the current control switching transistor and a time to turn ON the bypass switching transistor is controllable by adjusting a power-supply voltage to be supplied to the inverter circuit.

9. A display device comprising:
a display region including a plurality of light-emitting diodes and a plurality of pixel circuits configured to control light emission of the plurality of light-emitting diodes; and
a control circuit disposed outside the display region and configured to control the plurality of pixel circuits,
wherein each of the plurality of pixel circuits includes:
a constant current circuit;
a pulse width modulation circuit;
a current control switching transistor on a path of lighting current that is supplied from the constant current circuit and flows through the light-emitting diode; and
a bypass switching transistor connected to an anode of the light-emitting diode, the bypass switching transistor being configured to be controlled synchronously with the current control switching transistor, and
wherein the current control switching transistor is turned ON and then turned OFF by a first pulse signal based on a pulse control-signal from the pulse width modulation circuit and the bypass switching transistor is turned OFF and then turned ON by a second pulse signal based on the pulse control-signal from the pulse width modulation circuit to control an emission period of the light-emitting diode.
